(19) United States
(12) Patent Application Publication
(10) Pub. No.: US 2020/0175461 A1
(43) Pub. Date: Jun. 4, 2020

(54) METHOD AND SYSTEM FOR TWO-ECHELON INVENTORY ALLOCATION

(71) Applicants: Beijing Jingdong Shangke Information Technology Co., Ltd., Beijing (CN); JD.com American Technologies Corporation, Mountain View, CA (US)

(72) Inventors: Jie Lu, Mountain View, CA (US); Rong Yuan, Mountain View, CA (US)

(21) Appl. No.: 16/208,439

(22) Filed: Dec. 3, 2018

(51) Int. Cl. G06Q 10/08; G06Q 10/04; G06Q 10/06

(52) U.S. Cl. CPC G06Q 10/087; G06Q 10/083; G06Q 10/06315; G06Q 10/04

(57) ABSTRACT

Systems and methods for allocating inventory between a first level distribution center and multiple second level distribution centers. The method includes: providing, by a computing device, demands, inventory and price data of products in the first level distribution center and the second level distribution centers; defining, by the computing device, an object function having the demands, the inventory and the price data of the products as input; optimizing, by the computing device, the object function to obtain an optimization result; and delivering the products from the first level distribution center to the second level distribution centers based on the optimized result.

### CROSS-REFERENCES

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates generally to the field of e-commerce, and more particularly to methods and systems for efficiently allocating inventory to distribution centers at different hierarchical levels.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

E-commerce has undergone a hyper growth for years and giant online retail platforms provide millions of products for customers to choose from. For a pleasant online shopping experience, the customer may expect convenient order process and fast delivery of the purchased products. To facilitate the delivery of the products, some e-commerce providers have set up distribution centers and warehouses at different locations. However, allocation of products among those distributions center is a hard task.

Therefore, an unaddressed need exists in the art to address the aforementioned deficiencies and inadequacies.

### SUMMARY

In certain aspects, the present disclosure relates to a method for allocating inventory between a first level distribution center and a plurality of second level distribution centers. In certain embodiments, the method includes:

providing, by a computing device, demands, inventory and price data of products in the first level distribution center and the second level distribution centers;

defining, by the computing device, an object function having the demands, the inventory and the price data of the products as input;

optimizing, by the computing device, the object function to obtain an optimization result; and

delivering the products from the first level distribution center to the second level distribution centers based on the optimized result.

In certain embodiments, the object function is:

$$\begin{matrix}{min}_{δ , x , y} 𝔼 [ m ( k , δ , x , y ) ] \\ wherein \text{:} & ( 1 ) \\ m ( k , δ , x , y ) = {c}_{p} [ {y}_{0}^{k} + {\sum }_{i} ( {y}_{ri}^{k} + {y}_{fi}^{k} ) ] + {c}_{r} {\sum }_{i} {x}_{ri}^{k} , & ( 2 ) \\ {y}_{0}^{k} + {δ}_{0} {I}_{0} = {d}_{0}^{k} + {x}_{d 0}^{k} + {\sum }_{i} {x}_{ri}^{k} , ∀ k , & ( 3 ) \\ {δ}_{i} {I}_{0} + {I}_{i} = {x}_{di}^{k} + {x}_{fi}^{k} , ∀ i , k , & ( 4 ) \\ {y}_{ri}^{k} + {y}_{fi}^{k} + {x}_{fi}^{k} + {x}_{ri}^{k} = {d}_{i}^{k} , ∀ i , k , & ( 5 ) \\ {y}_{ri}^{k} = \frac{α}{1 - α} {x}_{ri}^{k} , ∀ i , k , & ( 6 ) \\ {\sum }_{i} {δ}_{i} = 1 , & ( 7 ) \\ {x}_{ri}^{k} \geq 0 , ∀ i , k , & ( 8 ) \\ {x}_{di}^{k} \geq 0 , ∀ i , k , & ( 9 ) \\ {x}_{fi}^{k} \geq 0 , ∀ i , k , & ( 10 ) \\ {δ}_{i} \geq 0 , ∀ i , & ( 11 ) \\ {y}_{ri}^{k} \geq 0 , ∀ i , k , and & ( 12 ) \\ {y}_{fi}^{k} \geq 0 , ∀ i , k . & ( 13 )\end{matrix}$$

In the above formulas, [symbol] is to take expectation value of the m function, i is an index of the second level distribution centers being a positive integer from 1 to n, k is an index of forecast scenarios being a positive integer from 1 to K, ∀k represents for all the K forecast scenarios, ∀i represents for all the n second level distribution centers;

δ represents allocation ratio, δ₀ represents allocation ratio of the first level distribution center, δᵢ represents allocation ratio of each one of the n second level distribution centers;

x represents quantity of the products, xᵣᵢ^{k} represents direct fulfilment quantity from the first level distribution center to each one of the second level distribution centers, x_{fi}^{k} represents local fulfilment quantity for each of the second level distribution centers, x_{d0}^{k} represents remaining inventory of the first level distribution center after fulfilment, x_{di}^{k} represents remaining inventory of each of the second level distribution centers after fulfilment;

y represents loss of the product, yᵣᵢ^{k} represents sale loss of each of the second level distribution centers due to direct fulfilment shipment delay of the first level distribution center, y_{fi}^{k} represents the sale loss of each of the second level distribution centers due to out of stock of the product in both the first and second distribution centers, y₀^{k} represents the sale loss of the first level distribution center due to out of stock of the product in the first level distribution center;

cₚ represents unit price of the product, cᵣ represents unit direct fulfilment cost for the product shipped from the first level distribution center to corresponding one of the second level distribution center, α represents sale loss ratio incurred when using direct fulfilment of the product from the first level distribution center instead of from the corresponding second level distribution center;

t₀ represents the initial inventory in the first level distribution center, Iᵢ represents initial inventory in corresponding one of the second level distribution centers; and

d₀^{k} represents demand of the first level distribution center, and dᵢ^{k} represents demand of corresponding one of the second level distribution centers.

In certain embodiments, cᵣ is a predetermined number that is in a range of 10%-50% of cₚ, and in one embodiments, is 10% of cₚ. In certain embodiments, a is a predetermined number that is in a range of 0-0.2, and in one embodiment is 0.1. In certain embodiments, cᵣ is 10% of cₚ and α is 0.1. In certain embodiments, n is a predetermined number that is in a range of 3-10 and K is a predetermined number that is in a range of 50-200. In one embodiment, K is about 100.

In certain embodiments, the method further includes, before the step of optimizing the object function:

retrieving a vendor lead time (VLT) for all products in the second level distribution centers;

providing a VLT demand for each of the products, wherein the VLT demand of each of the products is obtained by predicting sale of the product in a period of the VLT from the current time to the end of the current VLT period;

providing current inventories of the products in each of the second level distribution centers;

comparing the current inventory and the VLT demand of one of the products; and

when the current inventory is less than the VLT demand, selecting the corresponding one of the products to optimize the object function.

In certain embodiments, the method further includes, after obtaining the optimized result for each of the products: prioritizing the products based on shortage of the products in the second level distribution centers and importance of the products, and delivering the products based on the priority of the products.

In certain embodiments, each of the inventories I₀ and Iᵢ and each of the demands d₀^{k} and dᵢ^{k} is a vector having K dimensions.

In certain embodiments, the object function is a linear model solvable using a linear solve. The linear solve includes CPLEX, GUROBI, CBC, and SCIP.

In certain embodiments, each of the demands is in a form of a mean and a variance, and K sampling is performed on the demand to obtain a vector having K dimensions.

In certain embodiments, the optimized result includes at least one of allocation ratios and allocation quantities of the first level distribution center and the second level distribution centers.

In certain aspects, the present disclosure relates to a system for allocating inventory between a first level distribution center and a plurality of second level distribution centers. In certain embodiments, the system includes a computing device. The computing device has a processor and a storage device storing computer executable code. The computer executable code, when executed at the processor, is configured to perform the method described above.

In certain aspects, the present disclosure relates to a non-transitory computer readable medium storing computer executable code. The computer executable code, when executed at a processor of a computing device, is configured to perform the method as described above.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 schematically depicts a two-echelon inventory allocation system according to certain embodiment of the present disclosure.

FIG. 2 schematically depicts a computing system of a two-echelon inventory allocation system according to certain embodiment of the present disclosure.

FIG. 3 schematically depicts a method of allocating inventory according to certain embodiments of the present disclosure.

FIG. 4 schematically depict an example of an allocation system according to certain embodiments of the present disclosure.

FIG. 5 schematically depicts an inventory allocation system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise defined, “first”, “second”, “third” and the like used before the same object are intended to distinguish these different objects, but are not to limit any sequence thereof.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, “plurality” means two or more.

As used herein, the terms “comprising”, “including”, “carrying”, “having”, “containing”, “involving”, and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

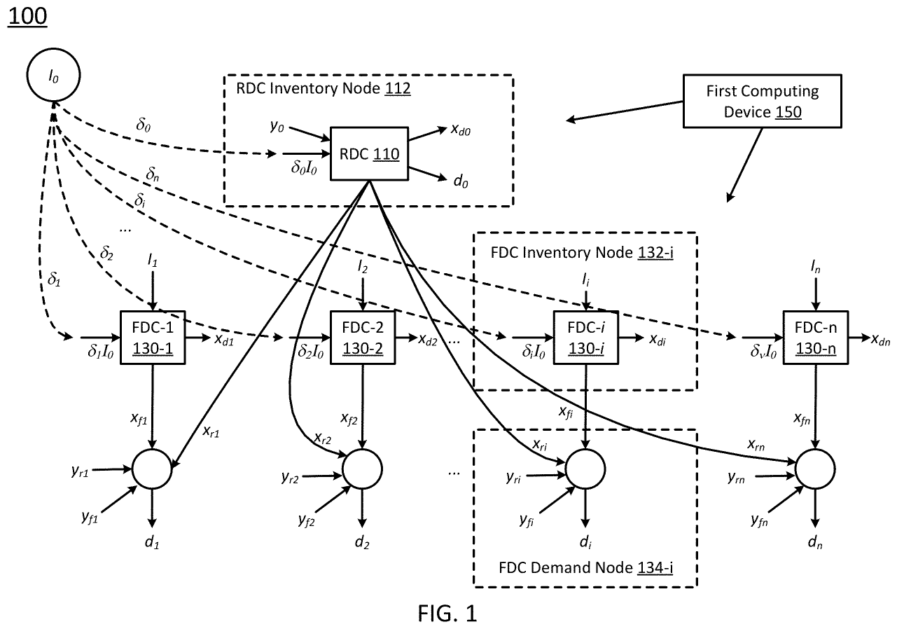

In certain aspects, the present disclosure relates to an inventory allocation system. In certain embodiments, as shown in FIG. 1, an inventory allocation system 100 includes a regional distribution center (RDC) 110, multiple front distribution center (FDC) 130, and an inventory allocation computing device in communication with the RDC 110 and the FDCs 130. The multiple FDCs 130 includes n FDCs 130-1, 130-2, . . . , 130-n. The RDC 110 and the FDCs 130 form a two-echelon or two-tire distribution network, where each high level RDC 110 includes several low level FDCs. For example, there may be a limited number of RDCs 110 in a country (such as 1-10 RDCs), and each RDC 110 has several FDCs (such as 2-8). In certain embodiments, based on geography, transportation and economic development, a country may have about 8 RDCs 110 and about 28 FDCs 130. Each RDC 110 covers demands from its associated metropolitan areas as well as its downstream FDCs 130. Each FDC covers the demand from its associated metropolitan areas. The two-echelon distribution system of RDCs 110 and FDCs 130 is novel at least because a high level RDC 110 has its own demand by customers and delivers products directly to those customers. Further, when an SKU (product) is out of stock in an FDC 130, its high level RDC 110 can delivers the SKU (if the RDC 110 has the SKU in stock) directly to the customer covered by the FDC 130. The inventory allocation computing device 150 is configured to collect information from the RDC 110, the FDCs 130 and other computing servers, and manages the product distribution between the RDC 110 and the FDCs 130.

In certain embodiments, each RDC 110 replenishes its inventory from other manufacturers or third-party vendors and these vendors has a lead time called vendor lead time (VLT). For each SKU (product), there is a corresponding VLT estimated from placing of an order of the SKU by the RDC 110 to arrival of the SKU at the RDC 110. The VLT may be in a range from one or a few days up to about one month. In certain embodiments, VLT demand of an SKU is calculated from the current time to the arrival of a new batch of the SKU from the manufacturers or vendors, that is, from the current time to the next replenishment of the SKU in the RDC 110. Each FDC 130 replenishes its inventory from its upstream RDC 110 using the internal inventory allocation process. The process performs routinely (everyday) to determine which stock keeping unit (SKU) to allocate from the RDC 110 to the corresponding FDCs 130 and the corresponding allocation quantity. In certain embodiments, these allocated inventory can be delivered from the RDC 110 to the FDCs 130 and arrived at the same day to meet the FDC 130's same day demand. Kindly note an SKU correspond to a specific product in the system according to certain embodiments of the present disclosure.

In certain embodiments, a method for allocating a single SKU is as follows: A percentage, such as 20%, of the current available RDC inventory can be allocated to other FDCs 130. Based on each FDC's demand, the actual allocation quantities for all the FDCs are proportional to the FDC demands. However, the major drawback of this method is the inflexibility, because, due to the huge number of SKUs, it would be hard to change the RDC inventory allocation ratio for each single SKU manually. To solve this issue, the inventory allocation computing device 150 operates an allocation system according certain embodiments of the present disclosure, to provide optimal allocation in the system.

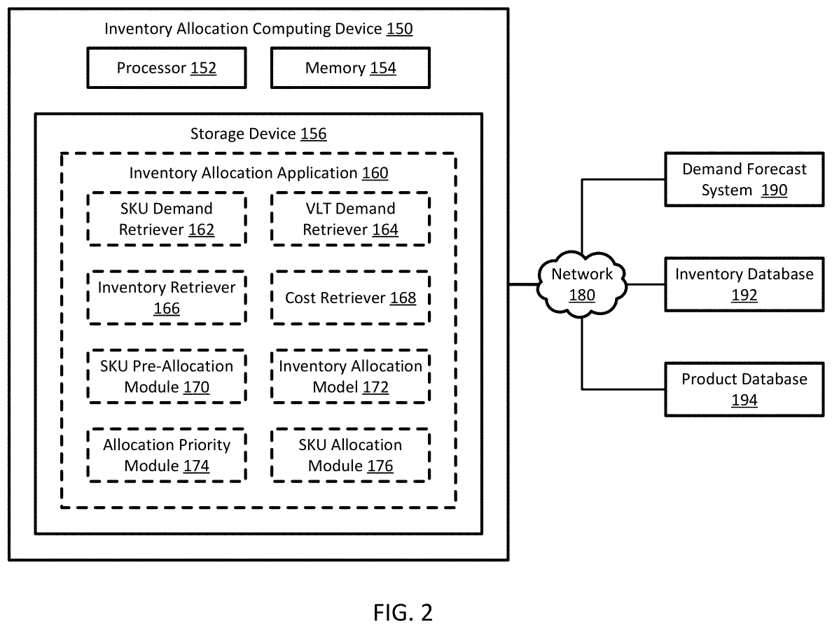

FIG. 2 schematically shows a computing system of the allocation system 100, where the computing systems are configured to manage the allocation between the RDC 110 and the FDCs 130. As shown in FIG. 2, the computing system of the allocation system 100 includes an inventory allocation computing device 150, and the inventory allocation computing device 150 is in communication with, via a network 180, external data or services including a demand forecast system 190, an inventory database 192, and a product database 194. In certain embodiments, the network 180 may be a wired or wireless network, and may be of various forms. Examples of the network 180 may include, but is not limited to, a local area network (LAN), a wide area network (WAN) including the Internet, or any other type of networks. The best-known computer network is the Internet.

The inventory allocation computing device 150 is configured to implement the inventory allocation between the RDC 110 and the FDCs 130. In certain embodiments, the inventory allocation computing device 150 may be a server computer, a cluster, a cloud computer, a general-purpose computer, or a specialized computer, which can collect demand and inventory information of the RDC 110 and the FDCs 130, and provide allocation for the products in the RDC 110.

The demand forecast system 190 may include a computing device such as a cloud computing device that provides predictions of the demands of the RDC 110 and the FDCs 130 mainly based on historical data. In certain embodiments, the demand forecast system 190 provides each SKU a daily forecast for the future time. In certain embodiments, each daily forecast may be a number of units or a range of a number of units of the SKU. For example, a daily forecast for a SKU in the next seven days may be respectively 200 units, 220 units, 280 units, 230 units, 200 units, 180 units, 190 units; or respectively 180-220 units, 200-240 units, 260-310 units, 200-260 units, 190-210 units, 170-190 units, 170-200 units. In certain embodiments, the forecast may also be a total number of units for the SKU in a predetermined time period, such as next 5 days. The daily forecast or forecast for a period of time may be a specific number of units, a number of units with a variance, or a distribution of numbers of units.

The inventory database 192 is stored in a computing device such as a cloud computing device that records inventory of the RDC 110 and the FDCs 130 and optionally other inventory related information and analysis.

The product database 194 is stored in a computing device such as a cloud computing device that provides product information. Each product has an SKU as identification. The product information of an SKU may include the identification of the product (i.e., the SKU), the category of the product, the name or title of the product, the dimensions and weight of a unit of the product, the color of the product, the unit price of the product, the direct fulfilment cost for the product shipped from the RDC 110 to the FDCs 130, the sale loss ratio incurred for the product when using the direct fulfilment from RDC 110 to the FDCs 130 (or to the customers of covered by the FDCs 130). Because each specific product has a corresponding SKU, product and SKU may be used interchangeably in this disclosure.

Those information in the demand forecast system 190, the inventory database 192, and the product database 194 are accessible to the inventory allocation computing device 150.

As shown in FIG. 2, the inventory allocation computing device 150 may include, without being limited to, a processor 152, a memory 154, and a storage device 156. In certain embodiments, the inventory allocation computing device 150 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices. In certain embodiments, the inventory allocation computing device 150 is a cloud computer or a server computer, and the processor 152, the memory 154 and the storage device 156 are shared resources provided over the Internet on-demand.

The processor 152 may be a central processing unit (CPU) which is configured to control operation of the inventory allocation computing device 150. The processor 152 can execute an operating system (OS) or other applications of the inventory allocation computing device 150. In some embodiments, the inventory allocation computing device 150 may have more than one CPU as the processor, such as two CPUs, four CPUs, eight CPUs, or any suitable number of CPUs.

The memory 154 can be a volatile memory, such as the random-access memory (RAM), for storing the data and information during the operation of the inventory allocation computing device 150. In certain embodiments, the memory 154 may be a volatile memory array. In certain embodiments, the inventory allocation computing device 150 may run on more than one memory 154.

The storage device 156 is a non-volatile data storage media for storing the OS (not shown) and other applications of the inventory allocation computing device 150. Examples of the storage device 156 may include non-volatile memory such as flash memory, memory cards, USB drives, hard drives, floppy disks, optical drives, or any other types of data storage devices. In certain embodiments, the inventory allocation computing device 150 may have multiple storage devices 156, which may be identical storage devices or different types of storage devices, and the applications of the inventory allocation computing device 150 may be stored in one or more of the storage devices 156 of the inventory allocation computing device 150. As shown in FIG. 2, the storage device 156 includes an inventory allocation application 160 (“Application”). The inventory allocation application 160 provides a system to collect product inventory and demand information, and provide allocation suggestions to optimize product distribution. In certain embodiments, the inventory allocation application 160 is performed regularly, such as daily. For each time of updating, inventory allocation application 160 is configured to retrieve most current data or most recent historical data. In certain embodiments, the inventory allocation application 160 is able to perform one round of computation in minutes. In certain embodiments, the inventory allocation application 160 is programed to run once a day at a predetermined time. The inventory allocation application 160, by daily updating the processed data, provided nearly real time distribution arrangement.

As shown in FIG. 2, the inventory allocation application 160 includes, among other things, an SKU demand retriever 162, a VLT demand retriever 164, an inventory retriever 166, a cost retriever 168, an SKU pre-allocation module 170, an inventory allocation model 172, an allocation priority module 174, and an SKU allocation module 176. In certain embodiments, the inventory allocation application 160 may include other applications or modules necessary for the operation of the modules 162-176. It should be noted that the modules are each implemented by computer executable codes or instructions, or data table or databases, which collectively forms one application. In certain embodiments, each of the modules may further include sub-modules. Alternatively, some of the modules may be combined as one stack. In other embodiments, certain modules may be implemented as a circuit instead of executable code. In certain embodiments, some of the modules of the inventory allocation application 160 may be located at a remote computing device, and the modules of the inventory allocation application 160 in the local computing device 150 communicate with the modules in the remote computing device via a wired or wireless network. In certain embodiments, the inventory allocation computing device 150 is a cloud computer server.

The SKU demand retriever 162 is configured to, when the inventory allocation application 160 is in operation, retrieve RDC demand d₀ and FDC demands d₁ to dᵢ from the demand forecast system 190 for each SKU or product having the SKU. In certain embodiments, the RDC demand d₀ and the n FDC demands are sale predictions of the SKU in a predetermined time period based on historical sales data and optionally future promotions of the SKUs. In certain embodiments, the predetermined time period is one day, one week, or a time between two shipments of the SKU from the RDC to the FDCs. For example, for each SKU, at the current time (day 0), if the next shipment date of the SKU is tomorrow (day 1), the predetermined time is 1 day, if the next shipment date is the day after tomorrow (day 2), the predetermined time is 2 days, and if the next shipment date is day m, the predetermined time is m days. In certain embodiments, each of the demands may be a number of units or distribution for the predetermined time. In certain embodiments, each of the demands may be a daily prediction for the predetermined time. For example, if the predetermined time is 5 days, the forecast provides daily demands separately for day 1 to day 5. Since the predetermined time is calculated from the current time, it is normally less than the VLT. In certain embodiments, the VLT is represented by a range to compensate the uncertainty. In certain embodiments, the VLT is a distribution, and the predetermined time is a preset number in the distribution. In certain embodiments, the prediction is performed by the demand forecast system 190 based on historical sales data and optionally future promotion information, etc. of the SKU. In certain embodiments, the RDC demand and the FDC demands are in a form of a vector having multiple dimensions, and each of the dimensions corresponds to a specific prediction. The dimensions of the vector represents the distribution of the predicated demand. If certain dimensions of the vector have the same predicted demand value, that value has a higher frequency. In certain embodiments, when a predicted demand has a form of a mean and a variance, the mean and variance information of the predicted demand is converted to the vector form. Table 1 shows an exemplary demand prediction according to the present disclosure. As shown in Table 1, each row corresponds to a vector having K dimensions, corresponding to K scenarios of prediction. For the RDC, the prediction of sales of the SKU is 850, 900, 900, . . . , and 1000 units/day. The repeat of the 900 unit/day indicates a high probability of selling 900 unit/day than the probabilities of selling 850 units/day or 1000 units/day. Each column represents one scenario. For example, in a first scenario, the prediction of RDC sale is 850 unit/day, while the prediction of FDC sales are 120 unit/day, 130/unit/day, . . . , and 110 unit/day.

TABLE 1
Demand prediction example of the
RDC and the FDCs of one SKU.

| | 1 | 2 | . . . | K |
|---|---|---|---|---|
| RDC | 850 unit/day | 800 unit/day | 900 unit/day | 1000 unit/day |
| FDC-1 | 120 unit/day | 150 unit/day | 160 unit/day | 190 unit/day |
| FDC-2 | 130 unit/day | 160 unit/day | 160 unit/day | 190 unit/day |
| . . . | | | | |
| FDC-n | 110 unit/day | 140 unit/day | 150 unit/day | 180 unit/day |

After obtaining the demand prediction, the RDC demand d₀ and the n FDC demands d₁ to dₙ of each SKU stored in the SKU demand retriever 162 are accessible to the inventory allocation module 172.

The VLT demand retriever 164 is configured to, when the inventory allocation application 160 is in operation, retrieve or receive VLT demand forecast (or predicted VLT demand) for an SKU at each of the FDCs 130, from the demand forecast system 190. VLT is the time for the RDC 110 to replenish its inventory from other manufacturers or third-party vendors, or in other words, the time needed from the moment the RDC 110 places an order of a product (SKU) to the moment the product is delivered to the RDC 110 by the manufacturer. In certain embodiments, the VLT for each SKU from a manufacturer or vender is recorded or calculated, and the demand forecast system 190 predicts or forecasts demand for the SKU at each FDCs 130 during a future time of VLT. For example, if the VLT for an SKU is 10 days, and the remaining VLT for an SKU (from the current time to the next replenishment) is 5 days, then the demand forecast system 190 is configured to forecast the demand for the SKU in the next 5 days (either a 5 day total forecast, a daily average forecast for the 5 days, or each day forecast for the 5 days). That 5 day demand is termed VLT demand or in route VLT demand. In certain embodiments, the VLT demand is in a form of a vector as shown in Table. 1, which indicates a forecast distributions. After obtaining the VLT demand prediction, the VLT demand stored in the VLT demand retriever 164 is accessible to the SKU pre-allocation module 170.

The inventory retriever 166 is configured to, when the inventory allocation application 160 is in operation, retrieve or receive initial inventory I₀ in the RDC 110 and initial inventory I₁ to Iₙ in each of the FDCs 130 from the inventory database 192. After obtaining the inventories, the initial RDC inventory I₀ and FDC inventories I₁ to Iₙ stored in the inventory retriever 166 are accessible to the SKU pre-allocation module 170 and the inventory allocation model 172.

The cost retriever 168 is configured to, when the inventory allocation application 160 is in operation, retrieve SKU unit price (or product price) cₚ, the direct fulfilment cost cᵣ for a single SKU shipped from RDC to FDC, and the sale loss ratio α incurred when using the direct fulfilment from RDC to FDC, from the product database 194. The retrieved cₚ, cᵣ, and α stored in the cost retriever 168 are accessible to the inventory allocation model 172. When an order is placed and location of a customer placing the order is covered by an FDC 130, the ordered product is shipped from the FDC 130 to the customer. However, if the product is not available in the FDC 130, the product needs to be shipped from the high lever RDC 110 corresponding to the FDC 130. The shipment from the RDC 110 may require a longer time, and sometimes causes split orders. The fulfilment of the order by the RDC 110 thus may cost more than a direct fulfilment by the FDC 130. The extra cost is defined as the direct fulfilment cost cᵣ for the single SKU shipped from the RDC 110 to the FDC 130 (or to a station of the FDC 130 or a customer covered by the FDC 130). In certain embodiments, the product database 194 (or optionally the cost retriever 168) defines the direct fulfilment cost cᵣ as a percentage of the SKU unit price cₚ. In certain embodiments, the direct fulfilment cost cᵣ is about 10%-50% of the SKU unit price cₚ. In certain embodiments, the product database 194 defines that the direct fulfilment cost cᵣ is about 10% of the SKU unit price cₚ. When direct fulfilment from RDC 110 to the FDC 130 of the SKU is required, the customer may not place an order of the SKU or may cancel the order due to the delayed shipment. Accordingly, the number of sales of the SKU may be less than it would be if the SKU is in stock in the FDC 130. In certain embodiments, the product database 194 (or optionally the cost retriever 168) defines this sale loss of the by a sale loss ratio α. In certain embodiments, the product database 194 defines the ratio as about 0-0.2, and in certain embodiments, the ratio is about 0.1.

The SKU pre-allocation module 170 is configure to, when the inventory allocation application 160 is in operation, retrieve VLT demands of all SKUs from the VLT demand retriever 164 and the initial FDC inventory I₁ to Iₙ for all the SKUs from the inventory retriever 166, and compare the inventory with the VLT demand for each SKU in each of the FDCs 130. When the inventory of that SKU is less than the VLT demand of that SKU in any of the FDCs 130, the SKU pre-allocation module 170 is further configured to add the corresponding SKU to the pre-allocation SKU list, and send the pre-allocation SKU list to the SKU allocation model 172. Here the VLT is the time between two replenishments of the RDC 110, but the VLT demand is the demand of the SKU (predicted sales of the SKU) in each FDC 130 from the current time to the next replenishment time. In other words, the VLT demand is the demand forecast for the predetermined time that is within the VLT, and normally is less than the VLT. For example, if the VLT is 10 days, and the next replenish time of the RDC 110 is in 5 days, then the VLT demand for an SKU in the corresponding FDC 130 is the predicted total sales of the SKU in that FDC in the next 5 days. For each SKU, the inventory in each of the FDCs 130 is compared with the corresponding VLT demand. Therefore, if in any of the FDCs 130 that the inventory of an SKU is less than the VLT demand of that SKU, the SKU is added to the pre-allocation list. By this type of determination, if there exists possible shortage for the SKU in even one FDC 130, that SKU would be included in the SKU pre-allocation list for further analysis.

The inventory allocation model 172 is configured to, upon receiving the pre-allocation SKU list from the SKU pre-allocation module 170, retrieve the RDC demand d₀ and the FDC demands d₁ to dᵢ from the SKU demand retriever 162, retrieve the initial RDC inventory I₀ and the initial FDC inventories I₁ to Iₙ from the inventory retriever 166, and retrieve the cₚ, cᵣ, and α from the cost retriever 168. The above retrieval is performed for each one of the SKUs in the pre-allocation SKU list using the identifications of the SKUs. The inventory allocation model 172 is further configured to use the data to solve the allocation of each of the SKUs by a network flow model, and send the result from the network flow model to the allocation priority module 174. The result includes allocation ratios for the RDC 110 and the FDCs 130. In certain embodiments, the network flow inventory application model is:

$${min}_{δ , x , y} 𝔼 [ m ( k , δ , x , y ) ] . \qquad ( 1 )$$

For the object function of formula (1), the inventory allocation model 172 looks for a minimum expected value of the function m(k, δ, x, y) for each of the SKUs, in which δ, x, y are variables. The inventory allocation model 172 further defines the object function as follows:

$$\begin{matrix}m ( k , δ , x , y ) = {c}_{p} [ {y}_{0}^{k} + {\sum }_{i} ( {y}_{ri}^{k} + {y}_{fi}^{k} ) ] + {c}_{r} {\sum }_{i} {x}_{ri}^{k} , & ( 2 ) \\ {y}_{0}^{k} + {δ}_{0} {I}_{0} = {d}_{0}^{k} + {x}_{d 0}^{k} + {\sum }_{i} {x}_{ri}^{k} , ∀ k , & ( 3 ) \\ {δ}_{i} {I}_{i} + {I}_{i} = {x}_{di}^{k} + {x}_{fi}^{k} , ∀ i , k , & ( 4 ) \\ {y}_{ri}^{k} + {y}_{fi}^{k} + {x}_{fi}^{k} + {x}_{ri}^{k} = {d}_{i}^{k} , ∀ i , k , & ( 5 ) \\ {y}_{ri}^{k} = \frac{α}{1 - α} {x}_{ri}^{k} , ∀ i , k , & ( 6 ) \\ {\sum }_{i} {δ}_{i} = 1 , & ( 7 ) \\ {x}_{ri}^{k} \geq 0 , ∀ i , k , & ( 8 ) \\ {x}_{di}^{k} \geq 0 , ∀ i , k , & ( 9 ) \\ {x}_{fi}^{k} \geq 0 , ∀ i , k , & ( 10 ) \\ {δ}_{i} \geq 0 , ∀ i , & ( 11 ) \\ {y}_{ri}^{k} \geq 0 , ∀ i , k , and & ( 12 ) \\ {y}_{fi}^{k} \geq 0 , ∀ i , k . & ( 13 )\end{matrix}$$

Those formula are used to process one SKU at a time. In those formula, [symbol] is to take expectation value of m function; k is one of the K numbers of scenarios, and ∀ means for all. The parameters in those formula include constants and variables. For the constants, d₀ is the RDC demand, and d₀^{k} is the RDC demand in the kth scenario; dᵢ is the demand of the ith FDC, and dᵢ^{k} is the demand of the ith FDC in the kth scenario; I₀ is the RDC inventory, and I₀^{k} is the RDC inventory in the kth scenario; Iᵢ is the inventory of the ith FDC, and Iᵢ^{k} is the inventory of the ith FDC in the kth scenario; cₚ is the unit price of the SKU (one product); cᵣ is the direct fulfilment cost for a single SKU shipped from RDC to FDC; and α is and the sale loss ratio incurred when using the direct fulfilment from RDC to FDC.

For the variables, δ₀ is the RDC inventory reserve ratio, δᵢ is the allocation ratio for the RDC to the ith FDC; xᵣᵢ^{k} is direct fulfillment quantity from RDC to the ith FDC, x_{fi}^{k} is local fulfilment quantity for the ith FDC, x_{d0}^{k} is RDC remaining inventory after fulfilment, x_{di}^{k} is the ith FDC remaining inventory after fulfilment; y₀^{k} is RDC sale loss due to out of stock, yᵣᵢ^{k} is FDC sale loss due to RDC direct fulfilment shipment delay, y_{fi}^{k} is FDC sale loss due to both RDC and FDC stock out.

The object function of formula (2) includes three items. The first item y₀^{k} is the cost associated with RDC sale loss, i.e., sale loss of an SKU due to out of stock of the SKU in the RDC 110; the second item yᵣᵢ^{k} and y_{fi}^{k} represent the sale loss due to RDC direct fulfilment delay or due to out of stock of the SKU in both the RDC 110 and the FDC 130; the third item is the direct fulfilment cost xᵣᵢ^{k} is direct fulfillment quantity from RDC to the ith FDC. The formula (3) represents the flow balance for the RDC inventory node 112; the formula (4) represents the flow balance for the FDC inventory node 132; and the formula (5) represents the flow balance for the FDC demand node 134. Constraint formula (6) indicates that there will be a fix proportion of direct fulfilment quantity from RDC to FDC that are lost due to the shipment delay. Constraint formula (7) ensures that the reserved ratio and all FDC allocation ratio are sum up to 1. Constraints formula (8)-(13) guarantee that all the variables are non-negative.

The network flow inventory allocation model defined by the formulas is a linear optimization model. In certain embodiments, the linear optimization model can be solved using a linear programming solver. The linear solver may include, among other things, CPLES®, GUROBI, coin-or branch and cut (CBC), solving constraint integer programs (SCIP), etc.

Referring back to FIG. 1, the RDC 110 is defined with an RDC inventory node 112, and each FDCs is defined with an FDC inventory node 132 and an FDC demand node 134. Kindly note FIG. 1 shows the balance for each SKU based on the data in a predetermined time. For example, if the next replenishment of the SKU is in 5 days, then all the data in FIG. 1 are related to that 5 days. But the computation of the parameters based on FIG. 1 for each SKU may be performed daily, and on each day, the predetermined time should be one day less than the predetermined time in the previous day. Further, in certain embodiments, the predetermined day is set to be greater than a threshold, such as 3-5 days. Therefore, even if the next replenishment is tomorrow, the computation may be performed by setting the predetermined time at 3-5 days, not 1 day.

As shown in FIG. 1, the RDC inventory node 112 has input y₀ and δ₀I₀, and output x_{d0}, d₀, xᵣ₁, xᵣ₂, . . . , xᵣᵢ, . . . , xᵣₙ. y₀ represents that when an SKU (product) is out of stock, the sale loss caused to the RDC 110 due to the out of stock of the SKU. I₀ represents the initial inventory (or total inventory) of the SKU in the RDC, which will be allocated among the RDC 110 and the n FDCs 130. δ₀ represents the allocation ratio of the initial inventory I₀ for the RDC 110. Accordingly, δ₀I₀ represents the number of SKU units that are allocated to the RDC 110. x_{d0} represents remaining inventory in the RDC 110 after fulfilment at the end of the predetermined time. d₀ represents demands of the SKU in the RDC 110 during the predetermined time. In other words, during the predetermined time, there are customer purchases in the metropolitan area that the RDC 110 directly serving, and in response to those customer purchases, the RDC 110 delivers those d₀ unit of products. When a customer, in an area covered by an FDC 130, places an order for a product, and the FDC 130 does not have the ordered product in stock, then the high level RDC 110 of the FDC 130 would fulfil the order directly. xᵣ₁, xᵣ₂, . . . , xᵣᵢ, . . . , xᵣₙ respectively represents the number of product unit that the RDC 110 directly delivers to the customers covered by FDC 130-1, FDC 130-2, . . . , and FDC 130-n. Under an ideal situation, the inputs and the output of the RDC inventory node 112 are balanced. In certain embodiments, the inventory allocation model 172 defines the RDC inventory node 112 using the formula (3) to represent the above balance. As shown in the formula (3), the formula considers all the K scenarios, and the balance is preferred for each of the scenarios.

As shown in FIG. 1, the FDC inventory node 132-i for the ith FDC center FDC-i has input Iᵢ and δᵢI₀, and output x_{di} and x_{fi}. Iᵢ represents the initial inventory of the SKU in the FDC-i at the beginning of the predetermined time. In certain embodiments, the initial inventory Iᵢ is obtained from the inventory database 192. δᵢ represents the allocation ratio of the initial inventory I₀ for the FDC-i. and accordingly, δᵢI₀ represents the number of SKU units that are allocated to the FDC-i. x_{di} represents remaining inventory in the FDC-i after fulfilment at the end of the predetermined time. Here fulfilment means that the orders of the SKU are delivered to the customers by the FDC-i during the predetermined time. x_{fi} represents the number of the SKU units that the FDC-i has directly fulfilled or completed to the customers during the predetermined time. Under an ideal situation, the inputs and the output of the FDC inventory node 132-i are balanced. In certain embodiments, the inventory allocation model 172 defines the FDC inventory node 132-i using the formula (4) to represent the above balance. As shown in the formula (4), the formula considers all the K scenarios, and the balance is preferred for each of the scenarios.

As shown in FIG. 1, the FDC demand node 134-i has input yᵣᵢ^{k}, y_{fi}^{k}, x_{fi}^{k}, xᵣᵢ^{k} and output dᵢ^{k}. When a customer covered by the FDC-i places an order for an SKU (product) and the SKU is out of stock in the FDC-i, the RDC 110 will ship the SKU directly to the customer instead of shipping from the FDC-i. Because the RDC 110 may be farther to the customer than the FDC-i, the shipment cost from the RDC 110 will be higher than the shipment cost from the FDC-i, and the customer may not place an order for the SKU or may cancel the order due to the delay of shipment. yᵣᵢ^{k} here represents the sale loss due to the fulfilment shipment delay from the RDC 110. Further, if the SKU is out of stock from both the RDC 110 and the FDC-i, the e-commerce platform may have to further delay the fulfilment considering restock of the SKU from a third party vendor. The customer may not place an order or may cancel the order after viewing the long fulfilment time needed. y_{fi}^{k} is a variable that represents the FDC-i sale loss due to the out of stock of the SKU in both the RDC 110 and the FDC-i. x_{fi}^{k} is a variable representing local fulfilment quantity of the SKU from the FDC-i, and xᵣᵢ^{k} is a variable representing direct fulfilment quantity of the SKU by the RDC 110 to the customer covered by the FDC-i. dᵢ^{k} is the demand of the customers coved by the FDC-i to the SKU. Under an ideal situation, the inputs and the output of the FDC demand node 134-i are balanced. In certain embodiments, the inventory allocation model 172 defines the FDC demand node 134-i using the formula (5) to represent the above balance. As shown in the formula (5), the formula considers all the K scenarios, and the balance is preferred for each of the scenarios.

In addition, the inventory allocation model 172 further defines the above mentioned variables using the formulas (6)-(13).

$${y}_{ri}^{k} = \frac{α}{1 - α} {x}_{ri}^{k} , ∀ i , k \qquad ( 6 )$$

In the formula (6), i indicates index of the FDCs 130, and there are the number of n FDCs 130 under the same RDC 110, that is, the FDCs 130-1, 130-2 to 130-n; K indicates the number of scenarios, where each scenario corresponds to a possibility of the predictions of the RDC demand and the corresponding FDC's demand; and for all the i and k, there is a relationship between the FDC-i sale loss due to RDC direct fulfilment shipping delay and the direct fulfilment quantity from RDC to the FDC-i. Here the FDC-i sale loss is shown by a number of units of the corresponding SKUs.

Σᵢδᵢ=1 (7)

In the formula (7), the summary of the allocation ratios δ₀ for the RDC, δ₁ for the FDC 130-1, δ₂ for the FDC 130-2, . . . , and δₙ for the FDC 130-n, equals to 1.

xᵣᵢ^{k}≥0, ∀i, k (8)

In the formula (8), for all the FDCs 1 to n, and for all the scenarios 1 to K, the direct fulfilment quantity from the RDC 110 to the customers of a specific FDC is greater than or equals to 0.

x_{di}^{k}≥0, ∀i, k (9)

In the formula (9), for all the FDCs 1 to n, and for all the scenarios 1 to K, the remaining inventory in a specific FDC after fulfilment (at the end of the pre-determined time) is greater than or equals to 0.

x_{fi}^{k}≥0, ∀i, k (10)

In the formula (10), for all the FDCs 1 to n, and for all the scenarios 1 to K, the local fulfilment quantity for a specific FDC during the pre-determined time is greater than or equals to 0.

δᵢ≥0, ∀i (11)

In the formula (11), for all the RDC 110 and the FDCs 1 to n, the allocation ratio for each of them is greater than or equals to 0.

yᵣᵢ^{k}≥0, ∀i, k (12)

In the formula (12), for all the FDCs 1 to n, and for all the scenarios 1 to K, the FDC sale loss due to RDC direct fulfilment shipment delay is greater than or equals to 0.

y_{fi}^{k}≥0, ∀i, k (13)

In the formula (13), for all the FDCs 1 to n, and for all the scenarios 1 to K, the FDC sale loss due to out of stock of both the RDC 110 and the specific FDC 130 is greater than or equals to 0.

The inventory allocation model 172 is configured to, after performing the object function optimization, provide optimized values for the variables, such as the allocation ratios (or allocation quantities) of each SKU in the RDC 110 and the FDCs 130, and send the optimized values to the allocation priority module 174.

The allocation priority module 174 is configured to, upon receiving the optimized allocation ratios (or quantities) of the SKU in each of the RDC 110 and the FDCs 130, calculate the priority of the SKUs using SKU-FDC shortage level and SKU importance information, rank the SKUs based on the calculated priority, and add the prioritized SKUs to an actual allocation list. The actual allocation list has a limit of the number of SKUs or a limit of the total quantity of the SKUs. In certain embodiments, the priority is only considered when there are transportation limit. In certain embodiments, the shortage level of the SKU in the FDC may be estimated by dividing the current inventory of the SKU by the average daily demand of the SKU, which is roughly remaining days the FDC can use the inventory to cover the demand. The smaller the value, the higher the SKU-shortage level. In certain embodiments, the SKU importance information is related to the demand variance of the SKU, where an SKU having greater demand variance gets a high priority. When the limit is reached, the inventory allocation module 174 stops adding the SKUs. In certain embodiments, after preparing the actual allocation list, the allocation priority module 174 is further configured to send the list to the SKU allocation module 176.

The SKU allocation module 176 is configured to, upon receiving the actual allocation list, determine the SKUs and the quantities of the SKUs for allocation from the RDC 110 to each of the FDCs 130, and instruct the delivery of those SKUs.

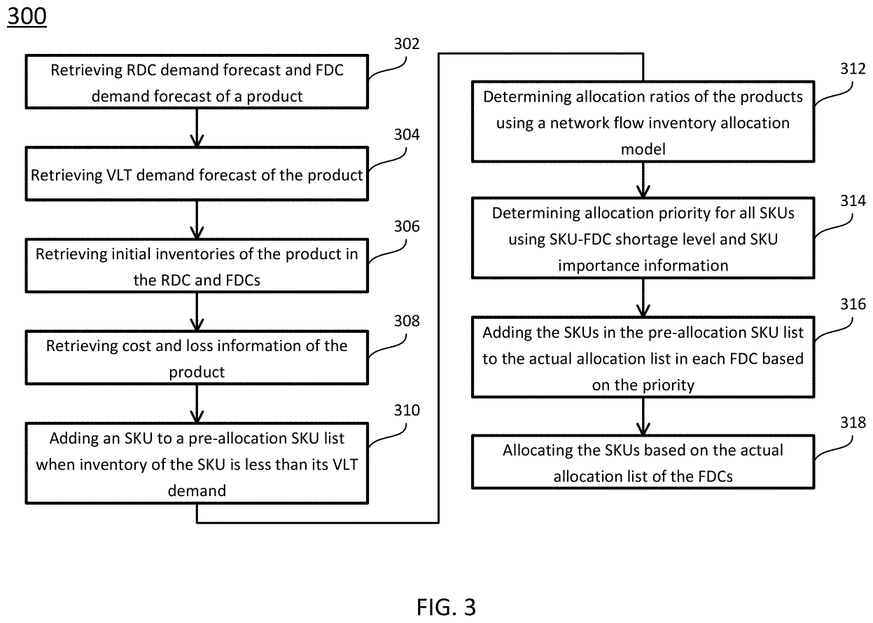

FIG. 3 depicts a method for inventory allocation according to certain embodiments of the present disclosure. In certain embodiments, a method 300 is implemented by the inventory allocation computing device 150 shown in FIG. 2. It should be particularly noted that, unless otherwise stated in the present disclosure, the steps of the method may be arranged in a different sequential order, and are thus not limited to the sequential order as shown in FIG. 3. Some detailed description which has been discussed previously may be omitted here for simplicity.

As shown in FIG. 3, at procedure 302, for all SKUs or products having the SKUs, the SKU demand retriever 162 retrieves RDC demand forecast (or predicted RDC demand) d₀ and FDC demand forecast (or predicted FDC demand) d₁ to dₙ from the demand forecast system 190. The demand forecast system 190 predicts the RDC demand d₀ and FDC demand d₀ to dₙ in a predetermined time based on historical sales and future promotions of the SKU. In certain embodiments, the predetermined time is the period from the current time to the next shipment time of the SKU, and could be in a range of 1 day to 7 days. The RDC demand d₀ and the n number of FDC demands d₁ to dₙ may be each in a form of a vector having K dimensions, and each dimension corresponds to a specific predicted number of the SKU. After retrieving the predicated RDC demand d₀ and the predicted FDC demands d₁ to dₙ, those demands are stored in the SKU demand retriever 162 and are accessible to the inventory allocation model 172.

At procedure 304, the VLT demand retriever 166 retrieves VLT demand forecast (or predicted VLT demand) in each of the FDCs from the demand forecast system 190. The VLT is the time for the RDC 110 to replenish its inventory from other manufacturers or third-party vendors, which could be a few days up to one month. The VLT demand forecast is the demand for the SKU during that VLT period. For example, if the VLT is 15 days, and the next replenish time is after 15 days, the VLT demand forecast is the demand of that SKU in the future 15 days in the FDCs 130; if the VLT is 15 days, and the next replenish time is after 5 days (10 days has passed from the previous replenishment), the VLT demand forecast is the demand of that SKU in the future 5 days in the FDCs 130. After obtaining the VLT demand forecast for the SKUs in each of the RDCs 130, those VLT demands are stored in the VLT demand retriever 164 and are accessible to the SKU pre-allocation module 170.

At procedure 306, the inventory retriever 166 retrieves initial inventory I₀ of the RDC 110 and initial inventories I₁ to Iₙ of the FDCs 130 from the inventory database 192, and the retrieved initial inventories are stored and are accessible to the SKU pre-allocation module 170 and the inventory allocation model 172.

At procedure 308, the cost retriever 168 retrieves, from the product database 194, SKU unit price cₚ, the direct fulfilment cost cᵣ for a single SKU shipped from RDC to FDC, and the sale loss ratio α incurred when using the direct fulfilment from RDC to FDC. The retrieved cₚ, cᵣ, and α are stored in the cost retriever 168 and are accessible to the inventory allocation model 172.

In certain embodiments, the procedures 302-308 are performed independently or in parallel, and do not have a definite sequential order. In other embodiments, the retrieval procedures of 302-308 may also be performed sequentially. In certain embodiments, those retrieving process may be updated regularly, and are ready for the following procedures to access.

At procedure 310, for each SKU, the SKU pre-allocation module 170 retrieves the VLT demand (the total amount of demand from current time until the next replenishment of the RDC 110) and the current inventory of the FDCs 130, and compares the VLT demand and the current inventory for each of the FDCs 130. If in at least one FDC 130 that the inventory is less than the VLT demand, the SKU pre-allocation module 170 adds the SKU to the pre-allocation SKU list. After finishing the comparison for all the SKUs, the SKU pre-allocation module 170 sends the pre-allocation SKU list to the inventory allocation model 172.

At procedure 312, upon receiving the SKU pre-allocation list, the inventory allocation model 172 retrieves, for each SKU in the SKU pre-allocation list, the RDC demand and the FDCs' demand from the SKU demand retriever 162; the initial RDC inventory and the initial

FDC's inventory from the inventory retriever 166; and the SKU unit price cₚ, the direct fulfilment cost cᵣ, and the sale loss ratio α of the SKU from the cost retriever 168. Then the inventory allocation model 172 performs the object function of the formulas (1) to (13) for each of the SKUs based on the retrieved data, to obtain the allocation ratios or/and allocation quantities of the SKU in the RDC 110 and the FDCs 130, and sends the obtained allocation ratios or quantities for the SKUs to the allocation priority module 174.

At procedure 314, upon receiving the SKUs (in the pre-allocation SKU list) with their respective allocation ratios or quantities, the allocation priority module 174 calculates the priority of those SKUs using SKU-FDC shortage level and SKU importance information. For example, if an allocation ratio or an exact allocation quantity of an SKU in one FDC is large, then it has a high priority; and if the SKU is needed by several FDCs, it has high priority for redistribution from the RDC to the FDCs.

At procedure 316, after calculating the priority, the allocation priority module 174 further adds the SKUs to an actual allocation list for each FDC 130, based on the priority of the SKUs in that FDC 130, until the number of SKU limit or SKU total quantity are reached, and sends the actual allocation list for each of the FDCs 130 to the SKU allocation module 176.

At procedure 318, the allocation module 176, based on the actual allocation list for the FDCs 130, prepares an allocation instruction containing the actual allocation list, such that allocation can be performed based on the instruction.

In a further aspect, the present invention is related to a non-transitory computer readable medium storing computer executable code. The code, when executed at a processor of a computing device, may perform the method 300 as described above. In certain embodiments, the non-transitory computer readable medium may include, but not limited to, any physical or virtual storage media. In certain embodiments, the non-transitory computer readable medium may be implemented as the storage device 156 of the inventory allocation computing device 150 as shown in FIG. 2.

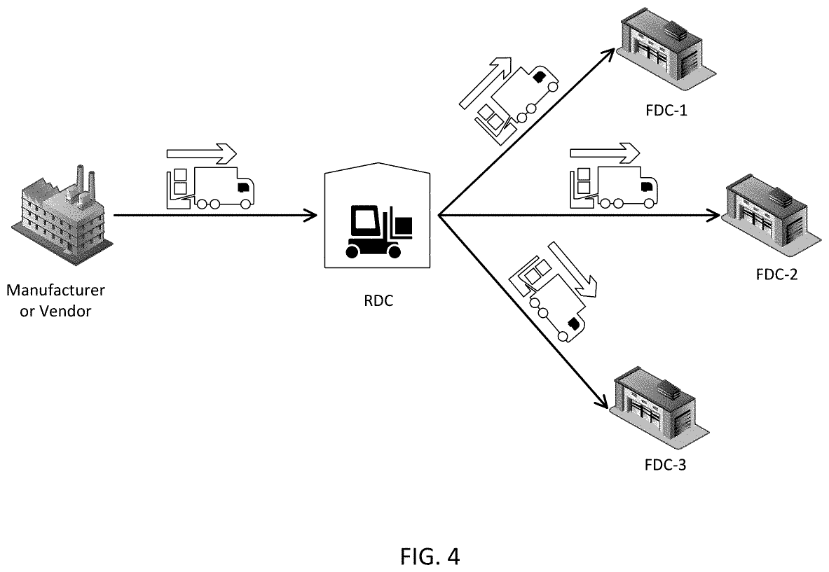

FIG. 4 schematically depict an example of an allocation system according to certain embodiments of the present disclosure. As shown in FIG. 4, the system includes an RDC and several FDCs, e.g., FDC-1, FDC-2 and FDC-3. When the RDC places an order for one SKU or product, the corresponding manufacturer or vendor ships the SKU within a vendor lead time. The RDC allocates the inventory of the SKU among the RDC and the FDCs, and transports certain amount of SKU to the FDCs. In certain embodiments, the allocation is based on the demands and the inventory of the RDC and the FDCs and the SKU price and loss information. In certain embodiments, the optimal target allocation ratio of the SKU among the RDC and the FDCs may be calculated using the method described above in related to FIG. 3.

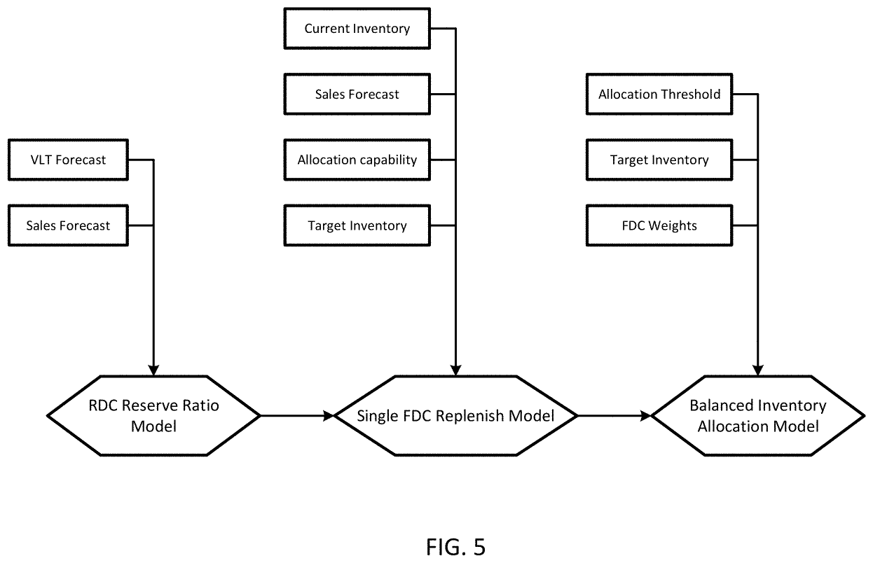

FIG. 5 schematically depicts an inventory allocation system according to certain embodiments of the present disclosure. As shown in FIG. 5, the inventory allocation system includes an RDC reserve ratio model, a single FDC replenish model, and a balanced inventory allocation model.

The RDC reserve ratio model is configured to obtain the optimal reservation ratio of an SKU in the RDC based on the VLT forecast and sales forecast of the SKU. In certain embodiments, the inventory allocation system uses a portion of the RDC inventory that is sufficient for the RDC demand before the next replenishment of the RDC as reference, and regard the rest of the RDC inventory as allocatable to the FDCs. Compared to setting a predetermined percentage of the RDC inventory as allocatable to the FDCs, this method increases the flexibility and accuracy for distributing certain amount of the SKU in the RDC to the FDCs.

The single FDC replenish model is configured to determine the time and quantity of replenishing an SKU from the RDC based on the current inventory, the demand forecast, the allocation capacity and the target inventory of the SKU. In certain embodiments, for each FDC, the single FDC replenish model determines the SKU to be replenished based on the needs of the SKU (such as the demand forecast) instead of only based on the shortage of the SKU. Further, the single FDC replenish model controls the allocation quantity within a predetermined allocation quantity level.

The balanced inventory allocation model is configured to determine the allocation of an SKU to the FDCs based on the allocation threshold and target inventory of the SKU, as well as the FDC weights. The balanced inventory allocation model not only considers the priority or weights of the FDCs, but also ensures balanced quantity of the SKU to all the FDCs.

In certain embodiments, the system shown in FIG. 1 and FIG. 2 and the method shown in FIG. 3 are used to obtain an optimal reservation ratio of an SKU, and fulfils the function of the RDC reserve ratio model of FIG. 5; and the system and method are further used to obtain optimal allocation ratio of the SKU in the FDCs, and fulfills the function of the single FDC replenish model. The reserve ratio and the allocation ratios obtained are key parameters for determining the balanced inventory allocation by the balanced inventory allocation model.

Certain embodiments of the present disclosure, among other things, determined the allocation ratio or quantity from the RDC to each of the FDCs for each SKU. The determination is performed using the network flow inventory allocation model. The obtained allocation ratio or quantity provide optimal solution for the inventory allocation plan, and the optimal solution improves the RDC and FDC local fulfilment rate and improves the fulfilments service level.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for allocating inventory between a first level distribution center and a plurality of second level distribution centers, the method comprising:
providing, by a computing device, demands, inventory and price data of products in the first level distribution center and the second level distribution centers;
defining, by the computing device, an object function having the demands, the inventory and the price data of the products as input;
optimizing, by the computing device, the object function to obtain an optimization result; and
delivering the products from the first level distribution center to the second level distribution centers based on the optimized result.

2. The method of claim 1, wherein the object function is:
$$\begin{matrix}{min}_{δ , x , y} 𝔼 [ m ( k , δ , x , y ) ] \\ wherein \text{:} & ( 1 ) \\ m ( k , δ , x , y ) = {c}_{p} [ {y}_{0}^{k} + {\sum }_{i} ( {y}_{ri}^{k} + {y}_{fi}^{k} ) ] + {c}_{r} {\sum }_{i} {x}_{ri}^{k} , & ( 2 ) \\ {y}_{0}^{k} + {δ}_{0} {I}_{0} = {d}_{0}^{k} + {x}_{d 0}^{k} + {\sum }_{i} {x}_{ri}^{k} , ∀ k , & ( 3 ) \\ {δ}_{i} {I}_{0} + {I}_{i} = {x}_{di}^{k} + {x}_{fi}^{k} , ∀ i , k , & ( 4 ) \\ {y}_{ri}^{k} + {y}_{fi}^{k} + {x}_{fi}^{k} + {x}_{ri}^{k} = {d}_{i}^{k} , ∀ i , k , & ( 5 ) \\ {y}_{ri}^{k} = \frac{α}{1 - α} {x}_{ri}^{k} , ∀ i , k , & ( 6 ) \\ {\sum }_{i} {δ}_{i} = 1 , & ( 7 ) \\ {x}_{ri}^{k} \geq 0 , ∀ i , k , & ( 8 ) \\ {x}_{di}^{k} \geq 0 , ∀ i , k , & ( 9 ) \\ {x}_{fi}^{k} \geq 0 , ∀ i , k , & ( 10 ) \\ {δ}_{i} \geq 0 , ∀ i , & ( 11 ) \\ {y}_{ri}^{k} \geq 0 , ∀ i , k , and & ( 12 ) \\ {y}_{fi}^{k} \geq 0 , ∀ i , k , & ( 13 )\end{matrix}$$
wherein [symbol] is to take expectation value of m function, i is an index of the second level distribution centers being a positive integer from 1 to n, k is an index of forecast scenarios being a positive integer form 1 to K, ∀k represents for all the K forecast scenarios, ∀i represents for all the n second level distribution centers;
wherein δ represents allocation ratio, δ₀ represents allocation ratio of the first level distribution center, δᵢ represents allocation ratio of each one of the second level distribution centers;
wherein x represents quantity of the products, xᵣᵢ^{k} represents direct fulfilment quantity from the first level distribution center to each one of the second level distribution centers, x_{fi}^{k} represents local fulfilment quantity for each of the second level distribution centers, x_{d0}^{k} represents remaining inventory of the first level distribution center after fulfilment, x_{di}^{k} represents remaining inventory of each of the second level distribution centers after fulfilment;
wherein y represents loss of the product, yᵣᵢ^{k} represents sale loss of each of the second level distribution centers due to direct fulfilment shipment delay of the first level distribution center, y_{fi}^{k} represents the sale loss of each of the second level distribution centers due to out of stock of the product in both the first and second distribution centers, y₀^{k} represents the sale loss of the first level distribution center due to out of stock of the product in the first level distribution center;
wherein cₚ represents unit price of the product, cᵣ represents unit direct fulfilment cost for the product shipped from the first level distribution center to corresponding one of the second level distribution center, α represents sale loss ratio incurred when using direct fulfilment of the product from the first level distribution center instead of from the corresponding second level distribution center;
wherein I₀ represents the initial inventory in the first level distribution center, Iᵢ represents initial inventory in corresponding one of the second level distribution centers; and
wherein d₀^{k} represents demand of the first level distribution center, and dᵢ^{k} represents demand of corresponding one of the second level distribution centers.

3. The method of claim 2, wherein cᵣ is 10%-50% of cₚ.

4. The method of claim 3, wherein α is in a range of 0-0.2.

5. The method of claim 4, wherein cᵣ is 10% of cₚ and α is 0.1.

6. The method of claim 2, wherein n is in a range of 3-10 and K is in a range of 50-200.

7. The method of claim 2, further comprising, before the step of optimizing the object function:
retrieving a vendor lead time (VLT) for all products in the second level distribution centers;
providing a VLT demand for each of the products, wherein the VLT demand of each of the products is obtained by predicting sale of the product from current time to the end of the VLT;
providing current inventories of the products in each of the second level distribution centers;
comparing the current inventory and the VLT demand of one of the products; and
when the current inventory is less than the VLT demand, selecting the corresponding one of the products to optimize the object function.

8. The method of claim 7, further comprising, after obtaining the optimized result for each of the products: prioritizing the products based on shortage of the products in the second level distribution centers and importance of the products, and delivering the products based on the priority of the products.

9. The method of claim 2, wherein each of the inventories I₀ and Iᵢ and each of the demands d₀^{k} and dᵢ^{k} is a vector having K dimensions.

10. The method of claim 1, wherein each of the demands is in a form of a mean and a variance, and K sampling is performed on the demand to obtain a vector having K dimensions.

11. The method of claim 1, wherein the optimized result comprises at least one of allocation ratios and allocation quantities of the first level distribution center and the second level distribution centers.

12. A system for allocating inventory between a first level distribution center and a plurality of second level distribution centers, the system comprising a computing device, the computing device comprising a processor and a storage device storing computer executable code, wherein the computer executable code, when executed at the processor, is configured to:
provide demands, inventory and price data of products in the first level distribution center and the second level distribution centers;
define an object function having the demands, the inventory and the price data of the products as input;
optimize the object function to obtain an optimization result; and
delivering the products from the first level distribution center to the second level distribution centers based on the optimized result.

13. The system of claim 12, wherein the object function is:
$$\begin{matrix}{min}_{δ , x , y} 𝔼 [ m ( k , δ , x , y ) ] \\ wherein \text{:} & ( 1 ) \\ m ( k , δ , x , y ) = {c}_{p} [ {y}_{0}^{k} + {\sum }_{i} ( {y}_{ri}^{k} + {y}_{fi}^{k} ) ] + {c}_{r} {\sum }_{i} {x}_{ri}^{k} , & ( 2 ) \\ {y}_{0}^{k} + {δ}_{0} {I}_{0} = {d}_{0}^{k} + {x}_{d 0}^{k} + {\sum }_{i} {x}_{ri}^{k} , ∀ k , & ( 3 ) \\ {δ}_{i} {I}_{0} + {I}_{i} = {x}_{di}^{k} + {x}_{fi}^{k} , ∀ i , k , & ( 4 ) \\ {y}_{ri}^{k} + {y}_{fi}^{k} + {x}_{fi}^{k} + {x}_{ri}^{k} = {d}_{i}^{k} , ∀ i , k , & ( 5 ) \\ {y}_{ri}^{k} = \frac{α}{1 - α} {x}_{ri}^{k} , ∀ i , k , & ( 6 ) \\ {\sum }_{i} {δ}_{i} = 1 , & ( 7 ) \\ {x}_{ri}^{k} \geq 0 , ∀ i , k , & ( 8 ) \\ {x}_{di}^{k} \geq 0 , ∀ i , k , & ( 9 ) \\ {x}_{fi}^{k} \geq 0 , ∀ i , k , & ( 10 ) \\ {δ}_{i} \geq 0 , ∀ i , & ( 11 ) \\ {y}_{ri}^{k} \geq 0 , ∀ i , k , and & ( 12 ) \\ {y}_{fi}^{k} \geq 0 , ∀ i , k , & ( 13 )\end{matrix}$$ [symbol]
is to take expectation value of m function, i is an index of the second level distribution centers being a positive integer from 1 to n, k is an index of forecast scenarios being a positive integer from 1 to K, ∀k represents for all the K scenarios, ∀i represents for all the n second level distribution centers;
δ represents allocation ratio, δ₀ represents allocation ratio of the first level distribution center, δᵢ represents allocation ratio of each one of the second level distribution centers;
x represents quantity of the products, xᵣᵢ^{k} represents direct fulfilment quantity from the first level distribution center to each one of the second level distribution centers, x_{fi}^{k} represents local fulfilment quantity for each of the second level distribution centers, x_{d0}^{k} represents remaining inventory of the first level distribution center after fulfilment, x_{di}^{k} represents remaining inventory of each of the second level distribution centers after fulfilment;
y represents loss of the product, yᵣᵢ^{k} represents sale loss of each of the second level distribution centers due to direct fulfilment shipment delay of the first level distribution center, y_{fi}^{k} represents the sale loss of each of the second level distribution centers due to out of stock of the product in both the first and second distribution centers, y₀^{k} represents the sale loss of the first level distribution center due to out of stock of the product in the first level distribution center;
cₚ represents unit price of the product, cᵣ represents unit direct fulfilment cost for the product shipped from the first level distribution center to corresponding one of the second level distribution center, α represents sale loss ratio incurred when using direct fulfilment of the product from the first level distribution center instead of from the corresponding second level distribution center;
I₀ represents the initial inventory in the first level distribution center, Iᵢ represents initial inventory in corresponding one of the second level distribution centers; and
d₀^{k} represents demand of the first level distribution center, and dᵢ^{k} represents demand of corresponding one of the second level distribution centers.

14. The system of claim 13, wherein cᵣ is 10%-50% of cₚ, α is in a range of 0-0.2, n is in a range of 3-10, and K is in a range of 50-200.

15. The system of claim 13, wherein the computer executable code is further configured to:
retrieve a vendor lead time (VLT) for all products in the second level distribution centers;
provide a VLT demand for each of the products, wherein the VLT demand of each of the products is obtained by predicting sale of the product from current time to the end of the VLT;
provide current inventories of the products in each of the second level distribution centers;
compare the current inventory and the VLT demand of one of the products; and
when the current inventory is less than the VLT demand, select the corresponding one of the products to optimize the object function.

16. The system of claim 13, wherein each of the inventories I₀ and Iᵢ and each of the demands d₀^{k} and dᵢ^{k} is a vector having K dimensions.

17. The method of claim 13, wherein each of the demands is in a form of a mean and a variance, and K sampling is performed on the demand to obtain a vector having K dimensions.

18. A non-transitory computer readable medium storing computer executable code, wherein the computer executable code, when executed at a processor of a computing device, is configured to:
provide demands, inventory and price data of products in the first level distribution center and the second level distribution centers;
define an object function having the demands, the inventory and the price data of the products as input;
optimize the object function to obtain an optimization result; and
delivering the products from the first level distribution center to the second level distribution centers based on the optimized result.

19. The non-transitory computer readable medium of claim 18, wherein the object function:
$$\begin{matrix}{min}_{δ , x , y} 𝔼 [ m ( k , δ , x , y ) ] \\ wherein \text{:} & ( 1 ) \\ m ( k , δ , x , y ) = {c}_{p} [ {y}_{0}^{k} + {\sum }_{i} ( {y}_{ri}^{k} + {y}_{fi}^{k} ) ] + {c}_{r} {\sum }_{i} {x}_{ri}^{k} , & ( 2 ) \\ {y}_{0}^{k} + {δ}_{0} {I}_{0} = {d}_{0}^{k} + {x}_{d 0}^{k} + {\sum }_{i} {x}_{ri}^{k} , ∀ k , & ( 3 ) \\ {δ}_{i} {I}_{0} + {I}_{i} = {x}_{di}^{k} + {x}_{fi}^{k} , ∀ i , k , & ( 4 ) \\ {y}_{ri}^{k} + {y}_{fi}^{k} + {x}_{fi}^{k} + {x}_{ri}^{k} = {d}_{i}^{k} , ∀ i , k , & ( 5 ) \\ {y}_{ri}^{k} = \frac{α}{1 - α} {x}_{ri}^{k} , ∀ i , k , & ( 6 ) \\ {\sum }_{i} {δ}_{i} = 1 , & ( 7 ) \\ {x}_{ri}^{k} \geq 0 , ∀ i , k , & ( 8 ) \\ {x}_{di}^{k} \geq 0 , ∀ i , k , & ( 9 ) \\ {x}_{fi}^{k} \geq 0 , ∀ i , k , & ( 10 ) \\ {δ}_{i} \geq 0 , ∀ i , & ( 11 ) \\ {y}_{ri}^{k} \geq 0 , ∀ i , k , and & ( 12 ) \\ {y}_{fi}^{k} \geq 0 , ∀ i , k , & ( 13 )\end{matrix}$$ [symbol]
is to take expectation value of m function, i is an index of the second level distribution centers being a positive integer from 1 to n, k is an index of forecast scenarios being a positive integer from 1 to K, ∀k represents for all the K scenarios, ∀i represents for all the n second level distribution centers;
δ represents allocation ratio, δ₀ represents allocation ratio of the first level distribution center, δᵢ represents allocation ratio of each one of the second level distribution centers;
x represents quantity of the products, xᵣᵢ^{k} represents direct fulfilment quantity from the first level distribution center to each one of the second level distribution centers, x_{fi}^{k} represents local fulfilment quantity for each of the second level distribution centers, x_{d0}^{k} represents remaining inventory of the first level distribution center after fulfilment, x_{di}^{k} represents remaining inventory of each of the second level distribution centers after fulfilment;
y represents loss of the product, yᵣᵢ^{k} represents sale loss of each of the second level distribution centers due to direct fulfilment shipment delay of the first level distribution center, y_{fi}^{k} represents the sale loss of each of the second level distribution centers due to out of stock of the product in both the first and second distribution centers, y₀^{k} represents the sale loss of the first level distribution center due to out of stock of the product in the first level distribution center;
cₚ represents unit price of the product, cᵣ represents unit direct fulfilment cost for the product shipped from the first level distribution center to corresponding one of the second level distribution center, a represents sale loss ratio incurred when using direct fulfilment of the product from the first level distribution center instead of from the corresponding second level distribution center;
I₀ represents the initial inventory in the first level distribution center, Iᵢ represents initial inventory in corresponding one of the second level distribution centers; and
d₀^{k} represents demand of the first level distribution center, and dᵢ^{k} represents demand of corresponding one of the second level distribution centers.

20. The non-transitory computer readable medium of claim 19, wherein cᵣ is 10%-50% of cₚ, α is in a range of 0-0.2, n is in a range of 3-10, and K is in a range of 50-200.
